(19) United States
(12) Patent Application Publication
(10) Pub. No.: US 2026/0100601 A1
(43) Pub. Date: Apr. 9, 2026

(54) APPARATUS AND METHOD FOR CONTROLLING BATTERY BASED ON USER'S SELECTION

(71) Applicants: Hyundai Motor Company, Seoul (KR); Kia Corporation, Seoul (KR)

(72) Inventors: Min-Gyu Park, Hwaseong (KR); Yunjeong Nam, Hwaseong (KR); Donggil Ha, Hwaseong (KR); Jiyeong Seo, Hwaseong (KR)

(21) Appl. No.: 19/172,218

(22) Filed: Apr. 7, 2025

(30) Foreign Application Priority Data
Oct. 8, 2024 (KR) 10-2024-0136349

(51) Int. Cl. H02J 7/00; B60L 50/60; B60L 58/12; B60L 58/16; H01M 10/42; H01M 10/44

(52) U.S. Cl. CPC H02J 7/933; H01M 10/44; B60L 50/60; B60L 58/12; B60L 58/16; H01M 10/425; H01M 2010/4271

(57) ABSTRACT

The disclosure provide a system and method for controlling an electronic vehicle battery according to user-selected strategies. Multiple battery operation modes (e.g., general, performance, and efficiency) may be stored, each offering distinct parameters for charging and discharging. A battery management system may present these modes to the driver, enable adjustments such as fast charging current and state-of-charge regions. A user may select a target usage period or performance preference, and the system calculates an expected battery life to guide the choid. The expected battery life may be then displayed—often as a table or graph—so the user can intuitively compare trade-offs among different modes. This adaptive approach manages battery health and optimizes performances based on the user's need and the real-word operation of the vehicle.

### CROSS-REFERENCE TO RELATED APPLICATION

This application claims under 35 U.S.C. § 119(a) the benefit of priority to Korean Patent Application No. 10-2024-0136349, filed Oct. 8, 2024, the entire disclosure of which is hereby incorporated by reference.

### BACKGROUND

### Technical Field

The present disclosure relates to an apparatus and a method for controlling a battery, and more particularly, to an apparatus and a method for controlling a battery to control charging/discharging of a high voltage battery used for eco-friendly vehicle.

### Background

In electric vehicles (EVs), hybrid electric vehicles (HEVs), and plug-in hybrid electric vehicles (PHEVs) which are eco-friendly vehicles, the degree of battery deterioration significantly affects vehicle performance. For example, a magnitude of a fast charging current is determined by reflecting a deterioration rate of a battery to a basic charging map set based on a condition of a new product (for example, 100% of state of health (SOH)) and a SOC (state of charge) control strategy may also be changed according to a deterioration state of the battery.

In the meantime, even in the case of the same battery, the vehicle performance is significantly affected by a battery operation strategy (usage strategy). For example, when the magnitude of the fast charging current is set high, a charging speed of the battery is increased and when a charging SOC region, a discharging SOC region, and an output limit region are set to increase the battery performance, is the vehicle's performance increases accordingly.

However, when the performance of the battery is increased, the deterioration of the battery becomes worse, which shortens the battery life. That is, the performance and the life of the battery are in a trade-off.

Accordingly, in the related art, vehicle manufacturing companies determined a battery operation strategy by appropriately considering performance and the life of the battery and the performance of the battery (a fast charging current, a charging SOC region, a discharging SOC region, and an output limit region) was set correspondingly to provide vehicles which were uniformly set to have the same battery performance for the same specification to consumers (users).

However, vehicle users have different perceptions of the importance of vehicle performance (battery performance) and battery life, depending on their preferences and usage purposes. For example, some users value vehicle performance, while others prioritize long-term battery life. In the related art, battery performance was uniformly set, preventing users from selecting the performance and life of the battery according to their needs.

### SUMMARY

At least some embodiments of the present disclosure have been created to solve the above-mentioned problems and provide an apparatus and method for controlling a battery based on user's selection which allow a user to select a battery operation strategy by considering a performance and a life expectancy of the battery.

Some embodiments of the present disclosure provide an apparatus and method for controlling a battery based on user's selection which change fast charging current setting, charging SOC region setting, discharging SOC region setting, and an output limit region setting of a battery according to a user's battery operation strategy.

Some embodiments of the present disclosure provide an apparatus and method for controlling a battery based on user's selection which predict and inform a life expectancy of a battery according to a battery operation strategy selected by a user.

According to some embodiments of the present disclosure, an apparatus for controlling a battery based on user's selection includes a user interface unit which receives a battery operation strategy from a user; a battery management unit which sets the battery performance corresponding to the battery operation strategy; and a battery control unit which controls at least one of charging and discharging of the battery corresponding to the battery performance setting.

The battery performance setting may comprise at least one of fast charging current setting, charging SOC region setting, discharging SOC region setting, and output limit region setting of the battery.

The battery operation strategy may comprise general type battery operation set as a default, performance type battery operation which has a battery performance higher than that of the general type battery operation, and an efficiency type battery operation which has a battery performance lower than that of the general type battery operation.

The battery management unit may output an expected battery life corresponding to the battery performance setting through the user interface unit.

In the meantime, according to an aspect of the present disclosure, a method for controlling a battery based on user's selection includes receiving a battery operation strategy from a user by a battery control apparatus; performing battery performance setting corresponding to the battery operation strategy by the battery control apparatus; and controlling at least one of charging and discharging of the battery corresponding to the battery performance setting, by the battery control apparatus.

The method may further comprise, after the setting of battery performance, outputting an expected battery life corresponding to the battery performance setting, by means of the battery control apparatus.

The battery performance setting may comprise at least one of fast charging current setting, charging SOC region setting, discharging SOC region setting, and output limit region setting of the battery.

The battery operation strategy may comprise general type battery operation set as a default, performance type battery operation which has a battery performance higher than that of the general type battery operation, and an efficiency type battery operation which has a battery performance lower than that of the general type battery operation.

According to the present disclosure, the user may select a battery operation strategy in consideration of the performance and a life expectancy of a battery to efficiently manage the battery in accordance with the user's preference and usage purpose.

Further, according to the present disclosure, the life expectancy of the battery is predicted and informed according to the battery operation strategy selected by the user so that the user may select an optimal battery performance by considering a desired vehicle usage period.

In some embodiments, a method for controlling a battery based on a user's selection, the method includes storing a plurality of battery operation strategies in a memory, each battery operation strategy defining at least one operating parameter for charging or discharging the battery and being associated with an expected battery life; presenting, via a user interface, the plurality of battery operation strategies together with their respective expected battery life; receiving, from a user, a selection of one of the battery operation strategies; and controlling at least one of charging or discharging of the battery in accordance with the selected battery operation strategy.

The method may further include receiving, from the user, a target battery usage period; comparing the target battery usage period to the expected battery life of each battery operation strategy stored in the battery management system; and recommending at least one battery operation strategy to the user based on the comparison.

The method may further include recalculating the expected battery life for the selected battery operation strategy based on battery-usage information obtained by the battery management system; and displaying the recalculated expected battery life to the user via the user interface.

The multiple battery operation strategies include a general-type strategy having a default battery-performance parameter; a performance-type strategy having a higher battery-performance parameter than the general-type strategy; and an efficiency-type strategy having a lower battery-performance parameter than the general-type strategy.

As discussed, the method and system suitably include use of a controller or processer.

In another embodiment, vehicles are provided that comprise an apparatus as disclosed herein.

### BRIEF DESCRIPTION OF THE DRAWINGS

The above and other aspects, features, and advantages of the present disclosure will become apparent from the detailed description of the following aspects in conjunction with the accompanying drawings, in which:

FIG. 1 is a diagram of an apparatus for controlling a battery based on user's selection according to some example embodiments of the present disclosure;

FIG. 2 is a flowchart illustrating a method for controlling a battery based on user's selection according to some example embodiments of the present disclosure;

FIG. 3 is a view illustrating battery performance setting according to a battery operation strategy according to some example embodiments of the present disclosure.

FIG. 4 is a view illustrating fast charging current control according to a battery operation strategy according to some example embodiments of the present disclosure;

FIG. 5 is a view illustrating an expected battery life according to a battery operation strategy according some example embodiments of the present disclosure as a table; and

FIG. 6 is a view illustrating an expected battery life according to a battery operation strategy according to some example embodiments of the present disclosure as a graph.

### DETAILED DESCRIPTION

Hereinafter, reference will be made in detail to example embodiments of the present disclosure, examples of which are illustrated in the accompanying drawings and described below, and wherever possible, the same or similar elements will be denoted by the same reference numerals even though they are depicted in different drawings and a redundant description thereof will thus be omitted. In the following description of the embodiments, suffixes, such as “module”, and “part”, are provided or used interchangeably merely in consideration of ease in statement of the specification, and do not have meanings or functions distinguished from one another. In the following description of the embodiments of the present disclosure, a detailed description of known functions and configurations incorporated herein will be omitted when it may make the subject matter of the present disclosure rather unclear. Further, the accompanying drawings will be exemplarily given to describe the embodiments of the present disclosure, and should not be construed as being limited to the embodiments set forth herein, and it will be understood that the embodiments of the present disclosure are provided only to completely disclose the disclosure and cover modifications, equivalents or alternatives which come within the scope and technical range of the disclosure.

In the following description of the embodiments, terms, such as “first” and “second”, are used only to describe various elements, and these elements should not be construed as being limited by these terms. These terms are used only to distinguish one element from other elements.

When an element or layer is referred to as being “connected to” or “coupled to” another element or layer, it may be directly connected or coupled to the other element or layer, or intervening elements or layers may be present. In contrast, when an element or layer is referred to as being “directly connected to” or “directly coupled to” another element or layer, there may be no intervening elements or layers present.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although example embodiment is described as using a plurality of units to perform the example process, it is understood that the example processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

The term “battery management system (BMS)” herein refers to an electronic control system (hardware and/or software) configured to monitor and manage battery parameters—such as voltage, current, temperature, State of Charge (SOC), and State of Health (SOH) —so as to ensure safe operation and optimize performance and lifespan.

The term “State of Charge (SOC)” herein refers to the ratio of the currently available capacity of the battery to its nominal or rated capacity.

The term “State of Health (SOH)” herein refers to a measure of the present condition of a battery compared to its ideal or ‘as-new’ state. SOH accounts for factors such as capacity fade and internal resistance to indicate how much the battery's performance may have deteriorated over time.

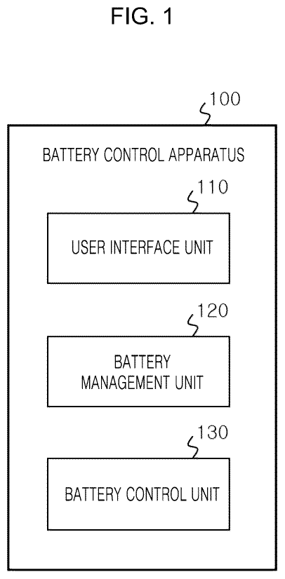

Hereinafter, an apparatus and method for controlling a battery based on user's selection and method according to the present disclosure will be described in detail with reference to FIGS. 1 to 6.

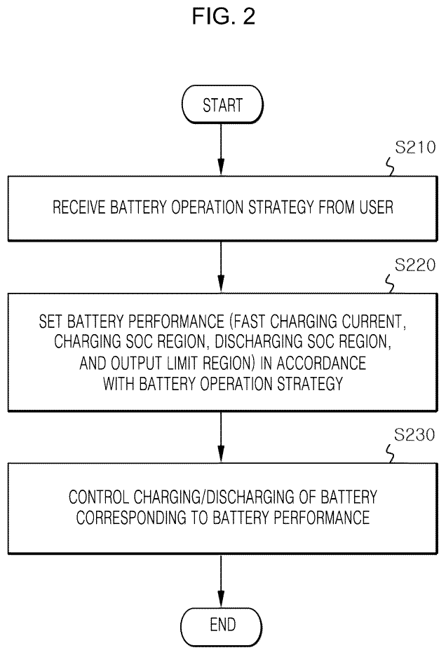

FIG. 1 is a diagram of an apparatus for controlling a battery based on user's selection according to an example embodiment of the present disclosure and FIG. 2 is a flowchart illustrating a method for controlling a battery based on user's selection according to an example embodiment of the present disclosure.

Referring to FIG. 1, the apparatus for controlling a battery based on user's selection 100 according to an example embodiment of the present disclosure includes a user interface unit 110, a battery management unit 120, and a battery control unit 130.

The user interface unit 110 receives a battery operation strategy from a user (see a step S210 of FIG. 2) to transmit the battery operation strategy to the battery management unit 120 and receives an expected battery life corresponding to the battery operation strategy from the battery management unit 120 to output (display) the expected battery life to the user.

The battery operation strategy is set to allow the user to select a battery management method (usage method) in accordance with the user's preference or usage purpose by considering the performance and/or life expectancy of the battery.

A battery operation strategy which is selectable by a user may be set by a vehicle manufacturing company by dividing a plurality of levels of battery operation strategy based on battery performance and/or life expectancy. According to the example embodiment of the present disclosure, the battery operation strategy may be divided into a general type battery operation, a performance type battery operation, and an efficiency type battery operation.

In this case, the general type battery operation is a battery operation strategy which is set as default by the vehicle manufacturing company by appropriately considering the battery performance and life. The performance type battery operation is a battery operation strategy which sets battery performance to be higher than that of the general type battery operation. The efficiency type battery operation is a battery operation strategy which sets the battery performance to be lower than the general type battery operation (to have a longer life instead). Desirably, the performance type battery operation and/or the efficiency type battery operation are sub-divided at a plurality of levels.

For reference, the user interface unit 110 may be implemented by a vehicle multi-media device, such as an audio video navigation (AVN), and may also be implemented as a part of a battery management system (BMS).

In the meantime, the battery management unit 120 sets a performance (for example, a fast charging current, a charging SOC region, a discharging SOC region, and an output limit region) corresponding to a battery operation strategy input by the user interface unit 110 (see a step 210 of FIG. 2) and calculates an expected battery life corresponding to the battery performance setting to output (display) the expected battery life through the user interface unit 110.

According to the example embodiment of the present disclosure, the battery performance setting includes fast charging current setting of a battery, charging SOC region setting of a battery, discharging SOC region setting of a battery, and output limit region setting of a battery.

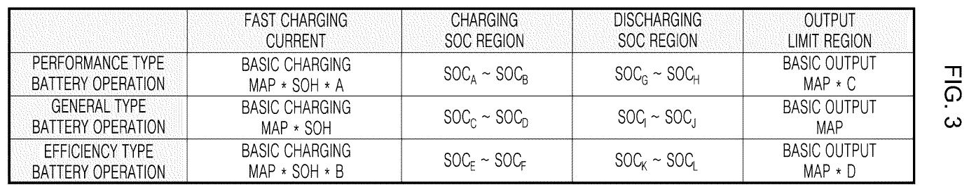

With regard to this, FIG. 3 is a view illustrating battery performance setting according to a battery operation strategy according to an example embodiment of the present disclosure.

Referring to FIG. 3, when the fast charging current of the battery is set, according to the general type battery operation, the fast charging current may be set by reflecting a deterioration rate of a battery to a basic charging map which is set as a default (for example, by multiplying a state of health (SOH) of the battery and a basic charging map). According to the performance type battery operation, the fast charging current may be set by multiplying a fast charging current of the general type battery operation by a factor A which is larger than 1 and according to the efficiency type battery operation, the fast charging current may be set by multiplying a fast charging current of the general type battery operation by a factor B which is smaller than 1.

For reference, here, the factor A which is larger than 1 may be derived through experiments as a value at which the abnormal deterioration of the battery is not caused and the factor B which is smaller than 1 may be derived by observing a trend of a battery life improvement effect through experiments.

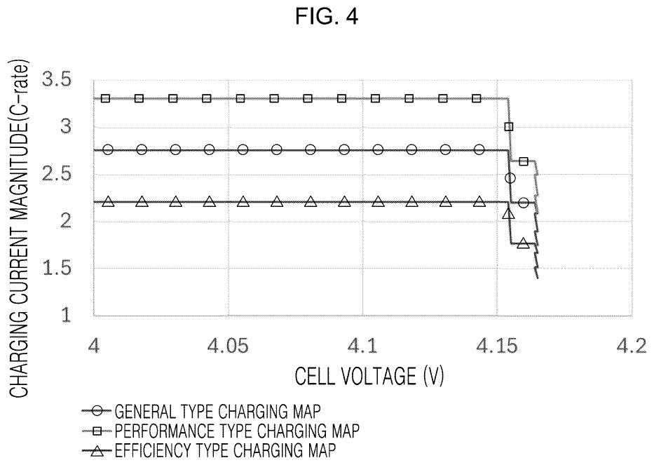

Further, the battery management unit 120, as illustrated in FIG. 4, controls the fast charging current of the battery according to the battery operation strategy (for example, the performance type battery operation, the general type battery operation, and the efficiency type battery operation) selected by the user. For example, according to the performance type battery operation, the fast charging is performed with 3.30 C-rate of the fast charging current, according to the general type battery operation, the fast charging is performed with 2.75 C-rate of the fast charging current, and according to the efficiency type battery operation, the fast charging is performed with 2.20 C-rate of the fast charging current.

Referring to FIG. 3 again, when the charging SOC region of the battery is set, according to the general type battery operation, the charging SOC region may be set with a charging SOC lower limit SOC_{C} and a charging SOC upper limit SOC_{D} which are set as a default, according to the performance type battery operation, the charging SOC region may be set with a charging SOC lower limit SOC_{A} which is smaller than the charging SOC lower limit SOC_{C} of the general type battery operation and a charging SOC upper limit SOC_{B} which is larger than the charging SOC upper limit SOC_{D} of the general type battery operation, and according to the efficiency type battery operation, the charging SOC region may be set with a charging SOC lower limit SOC_{E} which is larger than the charging SOC lower limit SOC_{C} of the general type battery operation and a charging SOC upper limit SOC_{F} which is smaller than the charging SOC upper limit SOC_{D} of the general type battery operation.

For reference, here, the charging SOC lower limit SOC_{A} and the charging SOC upper limit SOC_{B} of the performance type battery operation may be derived through the experiments as a value at which the abnormal deterioration of the battery is not caused and the charging SOC lower limit SOC_{E} and the charging SOC upper limit SOC_{F} of the efficiency type battery operation may be derived by comparing a trade off relationship of a life improved by reducing a usage area and a mileage marketability.

When the discharging SOC region of the battery is set, according to the general type battery operation, the discharging SOC region may be set with a discharging SOC lower limit SOC_{I} and a discharging SOC upper limit SOC_{J} which are set as a default, according to the performance type battery operation, the discharging SOC region may be set with a discharging SOC lower limit SOC_{G} which is smaller than the discharging SOC lower limit SOC_{I} of the general type battery operation and a discharging SOC upper limit SOC_{H} which is larger than the discharging SOC upper limit SOC_{J} of the general type battery operation, and according to the efficiency type battery operation, the discharging SOC region is set with a discharging SOC lower limit SOC_{K} which is larger than the discharging SOC lower limit SOC_{I} of the general type battery operation and a discharging SOC upper limit SOC_{I}, which is smaller than the discharging SOC upper limit SOC_{J} of the general type battery operation.

For reference, here, the discharging SOC lower limit SOC_{G} and the discharging SOC upper limit SOC_{H} of the performance type battery operation may be derived through the experiment as a value at which the abnormal deterioration of the battery is not caused and the discharging SOC lower limit SOC_{K} and the discharging SOC upper limit SOC_{I} of the efficiency type battery operation may be derived by comparing a trade off relationship of a life improved by reducing a usage area and a mileage marketability.

When the battery output limit region is set, according to the general type battery operation, the output limit region may be set as a basic output map which is set as a default, according to the performance type battery operation, the output limit region may be set by multiplying the basic output map of the general type battery operation by a factor C which is larger than 1, and according to the efficiency type battery operation, the output limit region may be set by multiplying the basic output map of the general type battery operation by a factor D which is smaller than 1.

For reference, here, the factor C which is larger than 1 may be derived through experiments as a value at which the abnormal deterioration of the battery is not caused and the factor D which is smaller than 1 may be derived by observing a tendency of a battery life improvement effect through experiments.

In the meantime, the battery management unit 120 calculates an expected battery life (desirably, an expected battery life at the current timing) corresponding to the setting of the battery performance to be displayed through the user interface unit 110, to guide the user to select a desired battery operation strategy.

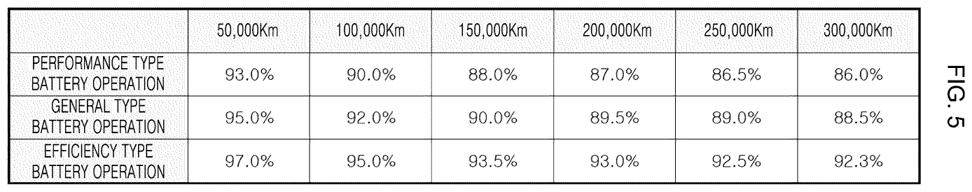

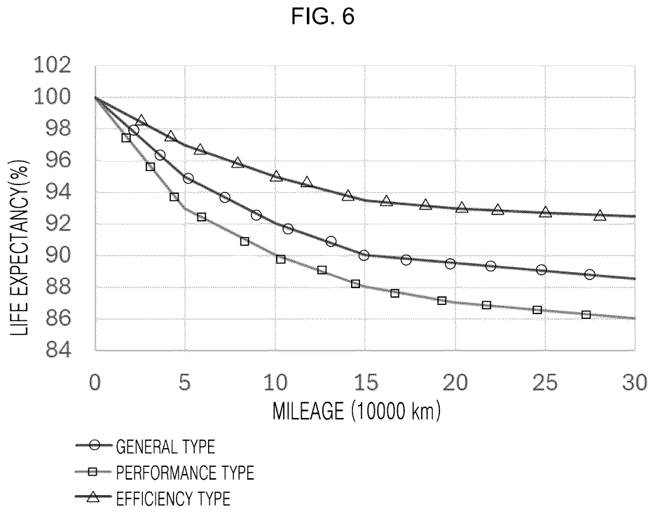

With regard to this, FIG. 5 is a view illustrating an expected battery life according to a battery operation strategy according to an example embodiment of the present disclosure as a table and FIG. 6 is a view illustrating an expected battery life according to a battery operation strategy according to an example embodiment of the present disclosure as a graph. The battery management unit 120 displays the expected battery life according to the battery operation strategy as a table or a graph so that the user may intuitively know the relationship of the performance and the life of the battery according to each battery operation strategy.

For reference, the battery management unit 120 may be implemented as a battery management system (BMS) or a part of the BMS as an example. The information about battery performance setting according to each battery operation strategy (for example, fast charging current setting, battery charging SOC region setting, battery discharging SOC region setting, and battery output limit region setting) and the life expectancy may be stored and managed in the database in the BMS.

Finally, referring to FIG. 1 again, the battery control unit 130 controls charging and/or discharging of the battery corresponding to the battery performance setting (for example, fast charging current setting, battery charging SOC region setting, battery discharging SOC region setting, and battery output limit region setting) according to the battery operation strategy selected by the user (see step S230 of FIG. 2) to efficiently manage the battery in accordance with the user's preference and usage purpose.

In the specification (particularly, in the claims) of the present disclosure, use of the term “above” and similar referential terms may refer to both the singular and the plural. In addition, when a range is stated in the present disclosure, the statement includes the invention to which individual values within the range are applied (unless there is a statement to the contrary), and is the same as a statement of the individual values constituting the range in the detailed description of the invention.

Unless there is a statement of an explicit order or a statement to the contrary regarding steps constituting the method according to the present disclosure, the steps may be performed in any appropriate order. The present disclosure is not necessarily limited by the described order of the steps. Use of any examples or illustrative terms (for example, etc.) in the present disclosure is merely to describe the present disclosure in detail, and unless limited by the claims, the scope of the present disclosure is not limited by the examples or illustrative terms. Further, those skilled in the art will appreciate that various modifications, combinations, and changes may be made according to design conditions and factors within the scope of the appended claims or their equivalents.

Therefore, the spirit of the present disclosure should not be limited to the above-described embodiments, and the scope of the appended claims described below as well as all scopes equivalent to or equivalently changed from the claims are within the scope of the spirit of the present disclosure.

1. An apparatus for controlling a battery based on user's selection, the apparatus comprising:
a user interface unit which receives a battery operation strategy from a user;
a battery management unit configuring battery performance setting in accordance with the battery operation strategy; and
a battery control unit configured to control at least one of charging and discharging of the battery in accordance with the battery performance setting.

2. The apparatus according to claim 1, wherein the battery performance setting comprises at least one of fast charging current setting, charging SOC region setting, discharging SOC region setting, and output limit region setting of the battery.

3. The apparatus according to claim 2, wherein the battery operation strategy comprises general type battery operation set as a default, performance type battery operation which has a battery performance higher than that of the general type battery operation, and an efficiency type battery operation which has a battery performance lower than that of the general type battery operation.

4. The apparatus according to claim 3, wherein when a fast charging current of the battery is set:
in case of the general type battery operation, the fast charging current is set by reflecting a deterioration rate of a battery to a basic charging map which is set as default,
in case of the performance type battery operation, the fast charging current is set by multiplying a fast charging current of the general type battery operation by a factor which is larger than 1, and
in case of the efficiency type battery operation, the fast charging current is set by multiplying a fast charging current of the general type battery operation by a factor which is smaller than 1.

5. The apparatus according to claim 3, wherein when a charging SOC region of the battery is set:
in case of the general type battery operation, the charging SOC region is set with a charging SOC lower limit and a charging SOC upper limit which are set as default,
in case of the performance type battery operation, the charging SOC region is set with a charging SOC lower limit which is smaller than the charging SOC lower limit of the general type battery operation and a charging SOC upper limit which is larger than the charging SOC upper limit of the general type battery operation, and
in case of the efficiency type battery operation, the charging SOC region is set with a charging SOC lower limit which is larger than the charging SOC lower limit of the general type battery operation and a charging SOC upper limit which is smaller than the charging SOC upper limit of the general type battery operation.

6. The apparatus for controlling a battery based on user's selection according to claim 3, wherein when a discharging SOC region of the battery is set,
in case of the general type battery operation, the discharging SOC region is set with a discharging SOC lower limit and a discharging SOC upper limit which are set as default,
in case of the performance type battery operation, the discharging SOC region is set with a discharging SOC lower limit which is smaller than the discharging SOC lower limit of the general type battery operation and a discharging SOC upper limit which is larger than the discharging SOC upper limit of the general type battery operation, and
in case of the efficiency type battery operation, the discharging SOC region is set with a discharging SOC lower limit which is larger than the discharging SOC lower limit of the general type battery operation and a discharging SOC upper limit which is smaller than the discharging SOC upper limit of the general type battery operation.

7. The apparatus for controlling a battery based on user's selection according to claim 3, wherein when a battery output limit region is set:
in case of the general type battery operation, the output limit region is set as a basic output map which is set as a default,
in case of the performance type battery operation, the output limit region is set by multiplying the basic output map of the general type battery operation by a factor which is larger than 1, and
in case of the efficiency type battery operation, the output limit region is set by multiplying the basic output map of the general type battery operation by a factor which is smaller than 1.

8. The apparatus for controlling a battery based on user's selection according to claim 1, wherein the battery management unit outputs an expected battery life in accordance with the battery performance setting through the user interface unit.

9. A method for controlling a battery based on user's selection, the method comprising:
receiving a battery operation strategy from a user by means of a battery control apparatus;
configuring battery performance setting in accordance with the battery operation strategy by means of the battery control apparatus; and
controlling at least one of charging and discharging of the battery in accordance with the battery performance setting, by means of the battery control apparatus.

10. The method according to claim 9, further comprising:
outputting an expected battery life in accordance with the battery performance setting, by means of the battery control apparatus.

11. The method according to claim 9, wherein the battery performance setting comprises at least one of fast charging current setting, charging SOC region setting, discharging SOC region setting, and output limit region setting of the battery.

12. The method according to claim 11, wherein the battery operation strategy comprises general type battery operation set as a default, performance type battery operation which has a battery performance higher than that of the general type battery operation, and an efficiency type battery operation which has a battery performance lower than that of the general type battery operation.

13. The method according to claim 12, wherein when a fast charging current of the battery is set:
in case of the general type battery operation, the fast charging current is set by reflecting a deterioration rate of a battery to a basic charging map which is set as default,
in case of the performance type battery operation, the fast charging current is set by multiplying a fast charging current of the general type battery operation by a factor which is larger than 1, and
in case of the efficiency type battery operation, the fast charging current is set by multiplying a fast charging current of the general type battery operation by a factor which is smaller than 1.

14. The method according to claim 12, wherein when a charging SOC region of the battery is set,
in case of the general type battery operation, the charging SOC region is set with a charging SOC lower limit and a charging SOC upper limit which are set as default,
in case of the performance type battery operation, the charging SOC region is set with a charging SOC lower limit which is smaller than the charging SOC lower limit of the general type battery operation and a charging SOC upper limit which is larger than the charging SOC upper limit of the general type battery operation, and
in case of the efficiency type battery operation, the charging SOC region is set with a charging SOC lower limit which is larger than the charging SOC lower limit of the general type battery operation and a charging SOC upper limit which is smaller than the charging SOC upper limit of the general type battery operation.

15. The method according to claim 12, wherein when a discharging SOC region of the battery is set,
in case of the general type battery operation, the discharging SOC region is set with a discharging SOC lower limit and a discharging SOC upper limit which are set as default,
in case of the performance type battery operation, the discharging SOC region is set with a discharging SOC lower limit which is smaller than the discharging SOC lower limit of the general type battery operation and a discharging SOC upper limit which is larger than the discharging SOC upper limit of the general type battery operation, and
in case of the efficiency type battery operation, the discharging SOC region is set with a discharging SOC lower limit which is larger than the discharging SOC lower limit of the general type battery operation and a discharging SOC upper limit which is smaller than the discharging SOC upper limit of the general type battery operation.

16. The method according to claim 12, wherein when a battery output limit region is set:
in case of the general type battery operation, the output limit region is set as a basic output map which is set as a default,
in case of the performance type battery operation, the output limit region is set by multiplying the basic output map of the general type battery operation by a factor which is larger than 1, and
in case of the efficiency type battery operation, the output limit region is set by multiplying the basic output map of the general type battery operation by a factor which is smaller than 1.

17. A method for controlling a battery based on a user's selection, the method comprising:
storing a plurality of battery operation strategies in a memory, each battery operation strategy defining at least one operating parameter for charging or discharging the battery and being associated with an expected battery life;
presenting, via a user interface, the plurality of battery operation strategies together with their respective expected battery life;
receiving, from a user, a selection of one of the battery operation strategies; and
controlling at least one of charging or discharging of the battery in accordance with the selected battery operation strategy.

18. The method according to claim 17, further comprising:
receiving, from the user, a target battery usage period;
comparing the target battery usage period to the expected battery life of each battery operation strategy stored in the battery management system; and
recommending at least one battery operation strategy to the user based on the comparison.

19. The method according to claim 17, further comprising:
recalculating the expected battery life for the selected battery operation strategy based on battery-usage information obtained by the battery management system; and
displaying the recalculated expected battery life to the user via the user interface.

20. The method according to claim 17, wherein the multiple battery operation strategies comprise:
a general-type strategy having a default battery-performance parameter;
a performance-type strategy having a higher battery-performance parameter than the general-type strategy; and
an efficiency-type strategy having a lower battery-performance parameter than the general-type strategy.
